(19) United States
(12) Patent Application Publication
(10) Pub. No.: US 2024/0348302 A1
(43) Pub. Date: Oct. 17, 2024

(54) RANK INFORMATION REPORTING

(71) Applicant: Telefonaktiebolaget LM Ericsson (publ), Stockholm (SE)

(72) Inventors: Claes TIDESTAV, Bålsta (SE); Daniele DAVOLI, Solna (SE); Andreas NILSSON, Göteborg (SE); Siva MURUGANATHAN, Stittsville, Ontario (CA)

(73) Assignee: Telefonaktiebolaget LM Ericsson (publ), Stockholm (SE)

(21) Appl. No.: 18/294,758

(22) PCT Filed: Aug. 3, 2022
(86) PCT No.: PCT/IB2022/057223

§ 371 Date: Feb. 2, 2024

Related U.S. Application Data
(60) Provisional application No. 63/230,317, filed on Aug. 6, 2021.

(51) Int. Cl. H04B 7/06; H04B 7/0456; H04B 17/318

(52) U.S. Cl. CPC H04B 7/0626; H04B 7/0486; H04B 17/328

(57) ABSTRACT

A method (1300) performed by a user equipment (1202). The method includes receiving (s1302) a report configuration transmitted by a network node (1204). The method also includes deciding (s1304), based on the report configuration, whether or not to include in a report corresponding to the report configuration at least first rank information associated with at least a first spatial filter. The first rank information specifies a first maximum number of downlink, DL, and/or uplink, UL, spatial layers supported by the UE.

### TECHNICAL FIELD

This disclosure relates to rank information reporting.

### BACKGROUND

### New Radio (NR)

The new generation mobile wireless communication system, which is referred to as “5G” or “new radio” (NR) supports a diverse set of use cases and a diverse set of deployment scenarios.

NR uses CP-OFDM (Cyclic Prefix Orthogonal Frequency Division Multiplexing) in the downlink (i.e. from an access network node to a user equipment (UE)) and both CP-OFDM and DFT-spread OFDM (DFT-S-OFDM) in the uplink (i.e. from UE to access network node). In the time domain, NR downlink and uplink physical resources are organized into equally-sized subframes of 1 ms each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespectively of the subcarrier spacing. Typical data scheduling in NR are per slot basis, an example is shown in FIG. 1 where the first two symbols contain physical downlink control channel (PDCCH) and the remaining 12 symbols contains physical data channel (PDCH), either a PDSCH (physical downlink data channel) or PUSCH (physical uplink data channel).

Different subcarrier spacing values are supported in NR. The supported subcarrier spacing values (also referred to as different numerologies) are given by Δf=(15×2^{a}) kHz where a is a non-negative integer. Δf=15 kHz is the basic subcarrier spacing that is also used in LTE. The slot durations at different subcarrier spacing are shown in FIG. 2.

In the frequency domain physical resource definition, a system bandwidth is divided into resource blocks (RBs), each corresponds to 12 contiguous subcarriers. The common RBs (CRB) are numbered starting with 0 from one end of the system bandwidth. The UE is configured with one or up to four bandwidth part (BWPs) which may be a subset of the RBs supported on a carrier. Hence, a BWP may start at a CRB larger than zero. All configured BWPs have a common reference, the CRB 0. Hence, a UE can be configured a narrow BWP (e.g. 10 MHz) and a wide BWP (e.g. 100 MHz), but only one BWP can be active for the UE at a given point in time. The physical RB (PRB) are numbered from 0 to N−1 within a BWP (but the 0:th PRB may thus be the K:th CRB where K>0).

The basic NR physical time-frequency resource grid is illustrated in FIG. 3, where only one resource block (RB) within a 14-symbol slot is shown. One OFDM subcarrier during one OFDM symbol interval forms one resource element (RE).

Downlink transmissions can be dynamically scheduled, i.e., in each slot the gNB transmits downlink control information (DCI) over PDCCH about which UE data is to be transmitted to and which RBs in the current downlink slot the data is transmitted on. PDCCH is typically transmitted in the first one or two OFDM symbols in each slot in NR. The UE data are carried on PDSCH. A UE first detects and decodes PDCCH and if decoding is successfull, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

### Synchronization Signal Block (SSB)

SSB is a broadcast signal in NR that aims to providing initial synchronization, basic system information and mobility measurements. The structure of SSB can be found in FIG. 4, and consists of one Primary Synchronization Signal (PSS), one Secondary Synchronization Signal (SSS) and a Physical Broadcast CHannel (PBCH). The PSS and SSS is transmitted over 127 sub-carriers, where the sub-carrier spacing could be 15/30 kHz for below 6 GHz and 120/240 kHz for above 6 GHz.

For low carrier frequencies it is expected that each cell transmits one SSB that covers the whole cell (see FIG. 5A) while for higher carrier frequencies several beamformed SSBs are expected to be needed to attain coverage over the whole cell, as illustrated in FIG. 5B. The maximum number of configurable SSBs per cell depends on the carrier frequency: 4 SSBs when carrier frequency is below 3 GHZ, 8 SSBs when carrier frequency is 3-6 GHZ, and 64 SSBs when carrier frequency is above 6 GHz. The SSBs are transmitted in an SSB transmission burst which could last up to 5 ms. The periodicity of the SSB burst are configurable with the following options: 5, 10, 20, 40, 80, 160 ms.

### Physical Downlink Control Channel (PDCCH)

Messages transmitted over the radio link to users can be broadly classified as control messages or data messages. Control messages are used to facilitate the proper operation of the system as well as proper operation of each UE within the system. Control messages could include commands to control functions such as the transmitted power from a UE, signaling of RBs within which the data is to be received by the UE or transmitted from the UE and so on. Examples of control messages in NR are the physical downlink control channel (PDCCH) which for example carry scheduling information and power control messages. Depending on what control data that is conveyed in the PDCCH, different downlink control information (DCI) formats can be used. The PDCCH messages in NR are demodulated using the PDCCH DMRS that is frequency multiplexed with DCI. This means that the PDCCH is a self-contained transmission which enables beamforming of the PDCCH.

In NR the PDCCH is located within one or several configurable/dynamic control regions called control resource sets (CORESETs). The size of the CORESET, w.r.t. time and frequency, is flexible in NR. In frequency domain, the allocation is done in units of 6 resource blocks (RBs) using a bitmap, and in time domain, a CORESET can consist of 1-3 consecutive OFDM symbols. A CORESET is then associated with a search space set to define when in time the UE should monitor the CORESET. The search space set includes for example parameters defining the periodicity, OFDM start symbol within a slot, slot-level offset, which DCI formats to blindly decode and the aggregation level of the DCI formats. This means that a CORESET and the associated search space set together define when in time and frequency the UE should monitor for control channel reception. Even though OFDM PDCCH can be located in any OFDM symbol in a slot, it is expected that the PDCCH mainly will be scheduled in the first few OFDM symbols of a slot in order to enable early data decoding and low-latency.

A UE can be configured with up to five CORESETs per “PDCCH-config”. The maximum number of CORESETs per serving cell is limited to 16. Each CORESET can be configured with a TCI state containing a DL-RS as spatial QCL indication, indicating to the UE a spatial direction from where the UE can assume to receive the PDCCHs corresponding to that CORESET. In order to improve the reliability (counteract RLF due to blocking) a UE can be configured with multiple CORESETs, each with different spatial QCL assumptions (TCI states). In this way, in case one beam pair link is blocked (for example a beam pair link associated with a first spatial QCL relation is blocked), the UE might still be reached by the network by transmitting PDCCH associated with a CORSET configured with another spatial QCL relation.

Transmission with Multiple Spatial Filters (a.k.a., “Beams”)

In high frequency range (FR2), multiple radio frequency (RF) spatial filters (or “beams”) may be used to transmit and receive signals at a gNB (5G access network node) and a UE. For each DL beam from a gNB, there is typically an associated best UE Rx beam for receiving signals from the DL beam. The DL beam and the associated UE Rx beam form a beam pair. The beam pair can be identified through a so-called beam management process in NR.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). For each DL RS, a UE can do a Rx beam sweep to determine the best Rx beam associate with the DL beam. The best Rx beam for each DL RS is then memorized by the UE. By measuring all the DL RSs, the UE can determine and report to the gNB the best DL beam to use for DL transmissions.

With the reciprocity principle, the same beam pair can also be used in the UL to transmit a UL signal to the gNB, often referred to as beam correspondence.

An example is shown in FIG. 6 where a gNB consists of a transmission point (TRP) with two DL beams each associated with a CSI-RS and one SSB beam. Each of the DL beams is associated with a best UE Rx beam, i.e., Rx beam #1 is associated with the DL beam with CSI-RS #1 and Rx beam #2 is associated with the DL beam with CSI-RS #2.

Due to UE movement or environment change, the best DL beam for a UE may change over time and different DL beams may be used in different times. The DL beam used for a DL data transmission in PDSCH can be indicated by a transmission configuration indicator (TCI) field in the corresponding DCI scheduling the PDSCH or activating the PDSCH in case of SPS. The TCI field indicates a TCI state which contains a DL RS associated with the DL beam. In the DCI, a PUCCH resource is indicated for carrying the corresponding HARQ A/N. The UL beam for carrying the PUCCH is determined by a PUCCH spatial relation activated for the PUCCH resource. For PUSCH transmission, the UL beam is indicated indirectly by a sounding reference signal (SRS) resource indicator (SRI), which points to one or more SRS resources associated with the PUSCH transmission. The SRS resource(s) can be periodic, semi-persistent, or aperiodic. Each SRS resource is associated with a SRS spatial relation in which a DL RS (or another periodic SRS) is specified. The UL beam for the PUSCH is implicitly indicated by the SRS spatial relation(s).

### Spatial Relations

Spatial relation is used in NR to refer to a spatial relationship between an UL channel or signal, such as PUCCH, PUSCH and SRS, and a DL (or UL) reference signal (RS), such as CSI-RS, SSB, or SRS. If an UL channel or signal is spatially related to a DL RS, it means that the UE should transmit the UL channel or signal with the same beam used in receiving the DL RS previously. More precisely, the UE should transmit the UL channel or signal with the same spatial filter used for the reception of the DL RS.

If a UL channel or signal is spatially related to a UL SRS, then the UE should apply the same spatial domain transmission filter for the transmission for the UL channel or signal as the one used to transmit the SRS.

Using DL RSs as the source RS in a spatial relation is very effective when the UE can transmit the UL signal in the opposite direction from which it previously received the DL RS, or in other words, if the UE can achieve the same Tx antenna gain during transmission as the antenna gain it achieved during reception. This capability (known as beam correspondence) will not always be perfect: due to, e.g., imperfect calibration, the UL Tx beam may point in another direction, resulting in a loss in UL coverage. To improve the performance in this situation, UL beam management based on SRS sweeping can be used, as illustrated in FIG. 7. To achieve optimum performance, the procedure depicted in FIG. 7 should be repeated as soon as the UEs Tx beam changes. FIG. 7 illustrates UL beam management using an SRS sweep. In the first step, the UE transmits a series of UL signals (SRS resources), using different Tx beams. The gNB then performs measurements for each of the SRS transmissions, and determines which SRS transmission was received with the best quality, or highest signal quality. The gNB then signals the preferred SRS resource to the UE. The UE subsequently transmits the PUSCH in the same beam where it transmitted the preferred SRS resource.

For PUCCH, up to 64 spatial relations can be configured for a UE and one of the spatial relations is activated by a Medium Access Control (MAC) Control Element (CE) for each PUCCH resource. The table below shows a PUCCH spatial relation information element (IE) that a UE can be configured in NR; it includes one of a SSB index, a CSI-RS resource identity (ID), and SRS resource ID as well as some power control parameters such as pathloss RS, closed-loop index, etc.

PUCCH-SpatialRelationInfo IE

-- ASN1START
-- TAG-PUCCH-SPATIALRELATIONINFO-START

| PUCCH-SpatialRelationInfo ::= | SEQUENCE { | |
|---|---|---|
| pucch-SpatialRelationInfoId | PUCCH-SpatialRelationInfoId, | |
| sevingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | PUCCH-SRS |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-SpatialRelationInfoExt-r16 ::= | SEQUENCE { |
| pucch-SpatialRelationInfoId-v1610 | PUCCH-SpatialRelationInfoId-v1610 |

OPTIONAL, -- Cond SetupOnly

| | |
|---|---|
| pucch-PathlossReferenceRS-Id-v1610 | PUCCH-PathlossReferenceRS-Id-v1610 |

OPTIONAL, --Need R
...
}

| | |
|---|---|
| PUCCH-SRS ::= | SEQUENCE { |
| resource | SRS-ResourceId, |
| uplinkBWP | BWP-Id |

}
-- TAG-PUCCH-SPATIALRELATIONINFO-STOP
-- ANS1STOP

For each periodic and semi-persistent SRS resource or aperiodic SRS with usage “non-codebook” configured, its associated DL CSI-RS is RRC configured. For each aperiodic SRS resource with usage “codebook” configured, the associated DL RS is specified in a SRS spatial relation activated by a MAC CE. An example is shown in the table below where one of a SSB index, a CSI-RS resource identity (ID), and SRS resource ID is configured.

| SRS-SpatialRelationInfo ::= | SEQUENCE { | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

For PUSCH, its spatial relation is defined by the spatial relation of the corresponding SRS resource(s) indicated by the SRI in the corresponding DCI.

### TCI State

### DL TCI States

Several signals can be transmitted from different antenna ports of a same base station. These signals can have the same large-scale properties such as Doppler shift/spread, average delay spread, or average delay. These antenna ports are then said to be quasi co-located (QCL).

If the UE knows that two antenna ports are QCL with respect to a certain parameter (e.g. Doppler spread), the UE can estimate that parameter based on one of the antenna ports and apply that estimate for receiving signal on the other antenna port.

For example, the TCI state may indicate a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that use analog beamforming to receive signals, since the UE need to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters. Typically, this is achieved by configuring the UE with a CSI-RS for tracking (TRS) for time/frequency offset estimation. To be able to use any QCL reference, the UE would have to receive it with a sufficiently good Signal-to-interference-plus-noise ratio (SINR). In many cases, this means that the TRS has to be transmitted in a suitable beam to a certain UE.

To introduce dynamics in beam and transmission point (TRP) selection, the UE can be configured through RRC signaling with M TCI states, where M is up to 128 in frequency range 2 (FR2) for the purpose of PDSCH reception and up to 8 in FR1, depending on UE capability.

Each TCI state contains QCL information, i.e. one or two source DL RSs, each source RS associated with a QCL type. For example, a TCI state contains a pair of reference signals, each associated with a QCL type, e-g-two different CSI-RSs {CSI-RS1, CSI-RS2} is configured in the TCI state as {qcl-Type1, qcl-Type2}={Type A, Type D}. It means the UE can derive Doppler shift, Doppler spread, average delay, delay spread from CSI-RS1 and Spatial Rx parameter (i.e. the RX beam to use) from CSI-RS2.

Each of the M states in the list of TCI states can be interpreted as a list of M possible beams transmitted from the network or a list of M possible TRPs used by the network to communicate with the UE. The M TCI states can also be interpreted as a combination of one or multiple beams transmitted from one or multiple TRPs.

A first list of available TCI states is configured for PDSCH, and a second list of TCI states is configured for PDCCH. Each TCI state contains a pointer, known as TCI State ID, which points to the TCI state. The network then activates via MAC CE one TCI state for PDCCH (i.e. provides a TCI for PDCCH) and up to eight active TCI states for PDSCH. The number of active TCI states the UE support is a UE capability, but the maximum is 8.

Each configured TCI state contains parameters for the quasi co-location associations between source reference signals (CSI-RS or SS/PBCH) and target reference signals (e.g., PDSCH/PDCCH DMRS ports). TCI states are also used to convey QCL information for the reception of CSI-RS.

Assume a UE is configured with 4 active TCI states (from a list of totally 64 configured TCI states). Hence, 60 TCI states are inactive for this particular UE (but some may be active for another UE) and the UE need not be prepared to have large scale parameters estimated for those. But the UE continuously tracks and updates the large scale parameters for the 4 active TCI states by measurements and analysis of the source RSs indicated by each TCI state. When scheduling a PDSCH to a UE, the DCI contains a pointer to one active TCI. The UE then knows which large scale parameter estimate to use when performing PDSCH DMRS channel estimation and thus PDSCH demodulation.

### TCI State Indication for UE-Specific PDCCH Via MAC CE

MAC CE signaling is used to indicate TCI state for UE specific PDCCH. The structure of the MAC CE for indicating TCI state for UE specific PDCCH is given in FIG. 8. As shown in FIG. 8, the MAC CE contains the following fields:

Serving Cell ID: This field indicates the identity of the Serving Cell for which the MAC CE applies. The length of the field is 5 bits;

CORESET ID: This field indicates a Control Resource Set identified with ControlResourceSetId as specified in 3GPP TS 38.331 V16.5.0 (hereafter “TS 38.331”), for which the TCI State is being indicated. In case the value of the field is 0, the field refers to the Control Resource Set configured by controlResourceSetZero as specified in TS 38.331. The length of the field is 4 bits; and

TCI State ID: This field indicates the TCI state identified by TCI-StateId as specified in TS 38.331 applicable to the Control Resource Set identified by CORESET ID field. If the field of CORESET ID is set to 0, this field indicates a TCI-StateId for a TCI state of the first 64 TCI-states configured by tci-States-ToAddModList and tci-States-ToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

The MAC CE for Indication of TCI States for UE-specific PDCCH has a fixed size of 16 bits.

In NR Rel-15, maxNrofControlResourceSets representing the maximum number of CORESETs per serving cell is 12. The maximum number of Bandwidth parts (BWPs) per serving cell is 4 in NR Rel-15. These maximum values are defined in TS 38.331 Section 6.4 as follows:

Multiplicity and type constraint definitions

-- ASN1START
-- TAG-MULTIPLICITY-AND-TYPE-CONSTRAINT-DEFINITIONS-START
...

| | | |
|---|---|---|
| maxNrofBWPs | INTEGER ::= 4 | -- Maximum number of BWPs per serving cell |

...

| | | |
|---|---|---|
| maxNrofControlResourceSets-1 | INTEGER ::= 11 | -- Max number of CoReSets configurable on |
| | | a serving cell minus 1 |

### UL TCI States

The existing way of using spatial relation for UL beam indication in NR is cumbersome and inflexible. To facilitate UL beam selection for UEs equipped with multiple panels, a unified TCI framework for UL fast panel selection is to be evaluated and introduced in NR Rel-17. Similar to DL, where TCI states are used to indicate DL beams/TRPs, TCI states may also be used to select UL panels and beams used for UL transmissions (i.e., PUSCH, PUCCH, and SRS).

It is envisioned that UL TCI states are configured by higher layers (i.e., RRC) for a UE in number of possible ways. In one scenario, UL TCI states are configured separately from the DL TCI states and each uplink TCI state may contain a DL RS (e.g., NZP CSI-RS or SSB) or an UL RS (e.g., SRS) to indicate a spatial relation. The UL TCI states can be configured either per UL channel/signal or per BWP such that the same UL TCI states can be used for PUSCH, PUCCH, and SRS. Alternatively, a same list of TCI states may be used for both DL and UL, hence a UE is configured with a single list of TCI states for both UL and DL beam indication. The single list of TCI states in this case can be configured either per UL channel/signal or per BWP information elements.

### CSI-RS

Similar to LTE, in NR a unique reference signal is transmitted from each antenna port at the gNB for downlink channel estimation at a UE. Reference signals for downlink channel estimation are commonly referred to as channel state information reference signal (CSI-RS). For N antenna ports, there will be N CSI-RS signals, each associated with one antenna port.

By measuring on CSI-RS, a UE can estimate the effective channel the CSI-RS is traversing including the radio propagation channel and antenna gains at both the gNB and the UE. Mathematically, this implies that if a known CSI-RS signal xᵢ (i=1, 2, . . . , Nₜₓ) is transmitted on the ith transmit antenna port at gNB, the received signal yⱼ (j=1, 2, . . . , Nᵣₓ) on the jth receive antenna port of a UE can be expressed as: yⱼ=h_{i,j}xᵢ+nⱼ, where h_{i,j} is the effective channel between the ith transmit antenna port and the jth receive antenna port, nⱼ is the receiver noise associated with the jth receive antenna port, Nₜₓ is the number of transmit antenna ports at the gNB and and Nᵣₓ is the number of receive antenna ports at the UE.

A UE can estimate the Nᵣₓ×Nₜₓ effective channel matrix H(H(i,j)=h_{i,j}) and thus the channel rank, precoding matrix, and channel quality. This is achieved by using a predesigned codebook for each rank, with each codeword in the codebook being a precoding matrix candidate. A UE searches through the codebook to find a rank, a codeword associated with the rank, and channel quality associated with the rank and precoding matrix to best match the effective channel. The rank, the precoding matrix and the channel quality are reported in the form of a rank indicator (RI), a precoding matrix indicator (PMI) and a channel quality indicator (CQI) as part of CSI feedback. This results in so-called channel dependent precoding, or closed-loop precoding. Such precoding essentially strives to focus the transmit energy into a subspace which is strong in the sense of conveying much of the transmitted energy to the UE.

A CSI-RS signal is transmitted on a set of time-frequency resource elements (REs) associated with an antenna port. For channel estimation over a system bandwidth, CSI-RS is typically transmitted over the whole system bandwidth. The set of REs used for CSI-RS transmission is referred to as CSI-RS resource. From a UE point of view, an antenna port is equivalent to a CSI-RS that the UE shall use to measure the channel. Up to 32 (i.e. Nₜₓ=32) antenna ports are supported in NR and thus 32 CSI-RS signals can be configured for a UE.

In NR, the following three types of CSI-RS transmissions are supported:
(1) Periodic CSI-RS Transmission: CSI-RS is transmitted periodically in certain subframes or slots. This CSI-RS transmission is semi-statically configured using parameters such as CSI-RS resource, periodicity and subframe or slot offset similar to LTE;
(2) Aperiodic CSI-RS Transmission: This is a one-shot CSI-RS transmission that can happen in any subframe or slot. Here, one-shot means that CSI-RS transmission only happens once per trigger. The CSI-RS resources (i.e., the resource element locations which consist of subcarrier locations and OFDM symbol locations) for aperiodic CSI-RS are semi-statically configured. The transmission of aperiodic CSI-RS is triggered by dynamic signaling through PDCCH. The triggering may also include selecting a CSI-RS resource from multiple CSI-RS resources; and
(3) Semi-Persistent CSI-RS Transmission: Similar to periodic CSI-RS, resources for semi-persistent CSI-RS transmissions are semi-statically configured with parameters such as periodicity and subframe or slot offset. However, unlike periodic CSI-RS, dynamic signaling is needed to activate and possibly deactivate the CSI-RS transmission. An example is shown in FIG. 9.

### CSI Reporting

In LTE, UEs can be configured to report CSI in periodic or aperiodic reporting modes. Periodic CSI reporting is carried on PUCCH while aperiodic CSI is carried on PUSCH. PUCCH is transmitted in a fixed or configured number of PRBs and using a single spatial layer (or rank 1) with QPSK modulation. PUSCH resources carrying aperiodic CSI reporting are dynamically allocated through uplink grants carried over PDCCH or enhanced PDCCH (EPDCCH), and can occupy a variable number of PRBs, use modulation states such as QPSK, 16QAM, and 64 QAM, as well as multiple spatial layers.

In NR, in addition to periodic and aperiodic CSI reporting as in LTE, semi-persistent CSI reporting will also be supported. Thus, three types of CSI reporting will be supported in NR as follows:
(1) Periodic CSI Reporting: CSI is reported periodically by the UE. Parameters such as periodicity and subframe or slot offset are configured semi-statically, by higher layer signaling from the gNB to the UE;
(2) Aperiodic CSI Reporting: This type of CSI reporting involves a single-shot (i.e., one time) CSI report by the UE, which is dynamically triggered by the gNB, e.g. by the DCI in PDCCH. Some of the parameters related to the configuration of the aperiodic CSI report is semi-statically configured from the gNB to the UE but the triggering is dynamic; and
(3) Semi-Persistent CSI Reporting: similar to periodic CSI reporting, semi-persistent CSI reporting has a periodicity and subframe or slot offset which may be semi-statically configured by the gNB to the UE. However, a dynamic trigger from gNB to UE may be needed to allow the UE to begin semi-persistent CSI reporting.

With regards to CSI-RS transmission and CSI reporting, the following combinations will be supported in NR:

| - | For periodic CSI-RS transmission | |
|---|---|---|
| | - | Semi-persistent CSI reporting is dynamically activated/deactivated |
| | - | Aperiodic CSI reporting is triggered by DCI |
| - | For semi-persistent transmission of CSI-RS, | |
| | - | Semi-persistent CSI reporting is activated/deactivated dynamically |
| | - | Aperiodic CSI reporting is triggered by DCI |
| - | For aperiodic transmission of CSI-RS, | |
| | - | Aperiodic CSI reporting is triggered by DCI |
| | - | Aperiodic CSI-RS is triggered dynamically |

### CSI Framework in NR:

It has been agreed in 3GPP that in NR, a UE can be configured with N≥1 CSI reporting settings, M≥1 Resource settings, and 1 CSI measurement setting, where the CSI measurement setting includes/≥1 links and value of L may depend on the UE capability.

At least the following configuration parameters are signaled via RRC at least for CSI acquisition:

| - | N, M, and L are indicated either implicitly or explicitly | |
|---|---|---|
| - | In each CSI reporting setting, at least: reported CSI parameter(s), CSI Type (I or II) if | |
| | reported, codebook configuration including codebook subset restriction, time-domain | |
| | behavior, frequency granularity for CQI and PMI, measurement restriction configurations | |
| - | In each Resource setting: | |
| | - | A configuration of S≥1 CSI-RS resource set(s) |
| | - | A configuration of Kₛ ≥1 CSI-RS resources for each set s, including at least: |
| | | mapping to REs, the number of ports, time-domain behavior, etc. |
| | - | Time domain behavior: aperiodic, periodic or semi-persistent |
| | - | RS type which encompasses at least CSI-RS |
| - | In each of the L links in CSI measurement setting: CSI reporting setting indication, | |
| | Resource setting indication, quantity to be measured (either channel or interference) | |
| | - | One CSI reporting setting can be linked with one or multiple Resource settings |
| | - | Multiple CSI reporting settings can be linked |

At least, the following are dynamically selected by L1 or L2 signaling, if applicable: One or multiple CSI reporting settings within the CSI measurement setting; One or multiple CSI-RS resource sets selected from at least one Resource setting; One or multiple CSI-RS resources selected from at least one CSI-RS resource set.

As described above (“Transmission with multiple beams”), for FR2 a suitable gNB beam can be determined from a beam sweep where the gNB transmit different DL-RS (e.g., CSI-RS or SSB) in different gNB beams. The UE performs measurement on the DL-RS and reports the best DL-RS indexes (and corresponding measurement values) back to the gNB. What kind of measurements and reporting that the UE should perform during a gNB beam sweep is mainly defined by the parameters reportQuantity/reportQuantity-r16 and nrOfReportedRS/nrofReportedRS-ForSINR-r16 in the CSI reporting setting IE in TS 38.331. By setting the parameter reportQuantity to either cri-RSRP or ssb-Index-RSRP (depending on if CSI-RS or SSB are used as DL-RS in the beam sweep) the UE will measure and report RSRP for the N gNB beams with highest RSRP. By setting the parameter reportQuantity-r16 to either cri-SINR-r16, or ssb-Index-SINR-r16 the UE will instead measure and report SINR for the N gNB beams with highest SINR. In addition, the network can determine the number of best gNB beams (N) that the UE should report during each gNB beam sweep by setting the parameter nrofReportedRS/nrofReportedRS-ForSINR-r16 to either 2 or 4 (if the fields are absent only the best beam is reported)

### Uplink Power Control in NR

Uplink power control is used to determine a proper transmit power for PUSCH, PUCCH and SRS to ensure that they are received by the gNB at an appropriate power level. The transmit power will depend on the amount of channel attenuation, the noise and interference level at the gNB receiver, and the data rate in case of PUSCH or PUCCH

The uplink power control in NR consists of two parts, i.e., open-loop power control and closed-loop power control. Open-loop power control is used to set the uplink transmit power based on the pathloss estimation and some other factors including the target receive power, channel/signal bandwidth, modulation and coding scheme (MCS), fractional power control factor, etc.

Closed-loop power control is based on explicit power control commands received from the gNB. The power control commands are typically determined based on some UL measurements at the gNB on the actual received power. The power control commands may contain the difference between the actual and the target received powers. Either cumulative or non-cumulative closed-loop power adjustments are supported in NR. Up to two closed loops can be configured in NR for each UL channel or signal. A closed loop adjustment at a given time is also referred as a power control adjustment state.

With multi-beam transmission in FR2, pathloss estimation needs to also reflect the beamforming gains corresponding to an uplink transmit and receive beam pair used for the UL channel or signal. This is achieved by estimating the pathloss based on measurements on a downlink RS transmitted over the corresponding downlink beam pair. The DL RS is referred to as a DL pathloss RS. A DL pathloss RS can be a CSI-RS or SSB. For the example shown in Error! Reference source not found., when a UL signal is transmitted in beam #1, CSI-RS #1 may be configured as the pathloss RS. Similarly, if a UL signal is transmitted in beam #2, CSI-RS #2 may be configured as the pathloss RS.

For a UL channel or signal (e.g., PUSCH, PUCCH, or SRS) to be transmitted in a UL beam pair associated with a pathloss RS with index k, its transmit power in a transmission occasion i within a slot in a bandwidth part (BWP) of a carrier frequency of a serving cell and a closed-loop index l (l=0,1) can be expressed as:

$$P ( i , k , l ) = min \{ \begin{matrix}{P}_{CMAX} ( i ) \\ {P}_{open - loop} ( i , k ) + {P}_{closed - loop} ( i , l )\end{matrix}$$

where P_{CMAX} (i) is the configured UE maximum output power for the carrier frequency of the serving cell in transmission occasion i for the UL channel or signal. Pₒₚₑₙ₋ₗₒₒₚ (i,k) is the open loop power adjustment and P_{closed-loop} (i,l) is the closed loop power adjustment. Pₒₚₑₙ₋ₗₒₒₚ (i,k) is given below,

$${P}_{open - loop} ( i , k ) = {P}_{O} + {P}_{RB} ( i ) + α PL ( k ) + Δ ( i )$$

where P_{O} is the nominal target receive power for the UL channel or signal and comprises a cell specific part P_{O,cell} and a UE specific part P_{O,UE}, P_{RB} (i) is a power adjustment related to the number of RBs occupied by the channel or signal in a transmission occasion, PL(k) is the pathloss estimation based on a pathloss reference signal with index k, a is fractional pathloss compensation factor, and Δ(i) is a power adjustment related to MCS. P_{closed-loop} (i,l) is given below:

$${P}_{closed - loop} ( i , l ) = \{ \begin{matrix}{P}_{closed - loop} ( i , l ) + {\sum }_{m = 0}^{M} δ ( m , l ) ; if cumulation is enabled \\ δ ( i , l ) ; if cumulation is disabled ( i . e . , absolute is enable )\end{matrix}$$

where δ(i,l) is a transmit power control (TPC) command value included in a DCI format associated with the UL channel or signal at transmission occasion i and closed-loop l; Σₘ₌₀^{M}δ(m,l) is a sum of TPC command values that the UE receives for the channel or signal and the associated closed-loop I since the TPC command for transmission occasion i−i_{O}.

Power control parameters P_{O}, P_{RB} (i), α, PL, Δ(i), δ (i,l) are generally configured separately for each UL channel or signal (e.g., PUSCH, PUCCH, and SRS) and may be different for different UL channels or signals.

### Maximum Permissible Exposure (MPE)

In 3GPP, two methods have been introduced to enable the UE to comply with regulatory exposure limits; reduced maximum output power (referred to as P-MPR) and reduced UL transmission duty cycle.

For FR2, maxUplinkDutyCycle-FR2 is a UE capability and indicates the maximum percentage of symbols during 1s that can be scheduled for uplink transmission regulatory exposure limits.

In case the field of UE capability maxUplinkDutyCycle-FR2 is not present or is present but the percentage of uplink symbols transmitted within any 1 s evaluation period is larger than maxUplinkDutyCycle-FR2, the UE can apply P-MPR to meet the regulatory exposure limits. By applying P-MPR the UE can reduce the maximum output power for a UE power class with x number of dB (where the range of x is still being discussed in 3GPP). For example, for UE power class 2 with a P-MPR value x=10 dB, the UE is allowed to reduce the maximum output power (Pcmax) from 23 dBm to 13 dBm (23 dBm−10 dB=13 dBm). Due to P-MPR and maxUplinkDutyCycle-FR2, the maximum uplink performance of a selected UL transmission path can be significantly deteriorated.

Since MPE issue may be highly directional in FR2, required P-MPR and maxUplinkDutyCycle would be uplink beam specific and would very likely be different among different candidate uplink beams across different UE panels. That means that certain beams/panels, i.e. ones that may be pointing towards human body, may have potentially very high required P-MPR/low duty cycle while some other beams/panels, i.e. ones whose beam pattern may not coincide human body, may have very low required P-MPR/high duty cycle.

UE Antenna Architecture at mmWave Frequencies

For UEs, the signals can arrive and emanate from all different directions. Hence, it is beneficial to have an antenna implementation at the UE which has the possibility to generate omni-directional-like coverage in addition to the high gain narrow beams used at mmWave frequencies to compensate for the poor propagation conditions. One way to increase the omni-directional coverage at a UE is to install multiple panels pointing in different directions as schematically illustrated in FIG. 10. As shown in FIG. 10, the UE has multiple panels pointing in different directions to attain omni like coverage at mmWave frequencies. Two TX/RX chains are switched between the three panels.

In order to reduce the complexity and heat generation at UEs at mmWave frequencies, current commercial UEs are typically equipped with two TX/RX chains (for mmWave frequencies), and where these two TX/RX chains are switched between the multiple UE panels depending on which UE panel that currently is best, as illustrated in FIG. 10.

Since MPE issues might occur for certain UE beams/UE panels (causing the UE to reduce the maximum output power for that UE beam/panel), the optimal beam pair link for DL and UL might differ. For example a first beam pair link associated with a first UE panel might be best for DL due to highest received power, however, due to MPE issues with that first UE panel, the optimal beam pair link for UL might be associated with a second UE panel that does not suffer from MPE issues. Therefore, it might be optimal for a UE (w.r.t to both DL and UL performance) to connect the TX chains to one panel and the RX chains to another panel, as schematically illustrated in FIG. 11. FIG. 11 shows two TX/RX chains are switched between the three panels, and where the two TX chains and tow RX chains are connected to different UE panels.

For some commercial UEs, the maximum number of TX and RX chains supported by a specific UE panel can differ between different UE panels. For example, assume that a UE has three UE panels (Panel1, Panel2 and Panel3), then Panel1 might support maximum 2 TX chains and maximum 2 RX chains, Panel 2 might support maximum 1 TX chain and maximum 1 RX chain, and Panel 3 might support no TX chain and maximum 2 RX chains (note that this is just one example and other variants are possible). Since maximum one layer can be supported per TX or RX chain, this means that different number of DL/UL layers (DL/UL rank) are supported for different UE panels. Note that with TX/RX chains, we do not mean for example a PA/LNA (since at mmWave frequencies a UE panel typically have one PA/LNA per antenna element of the panel). In this disclosure, we assume that for each TX chain of a UE panel, the UE panel supports one UL layer, and for each RX chain of a UE panel, the UE supports a DL layer.

### SUMMARY

Certain problems presently exist. For example, as described above, a UE can be equipped with different panels and where each panel can have a different number of TX/RX chains, which means that different panels supports different maximum (max) DL/UL rank. The simplest example is that the UE has two panels, and that one panel has 2 TX chains and 2 RX chains (max 2 DL/UL MIMO layers) and one panel has 1 TX chain and 1 RX chain (max 1 DL/UL MIMO layer). Depending on which panel is used for DL/UL data transmission/reception, the max number of layers the UE can support is either 1 or 2. In NR Release-16 (Rel-16), the UE report its max rank as a capability, but with the introduction of several panels at the UE, and where different panels support different ranks, the max rank may change depending on which UE panel the UE uses. Since the UE panel selection is unknown to the gNB, the gNB will not be aware of the current max rank supported by the UE, which could lead to sub-optimal transmission/reception/scheduling etc.

Accordingly, in one aspect there is provided a method performed by a UE. In one embodiment, the method includes the UE receiving a report configuration transmitted by a network node. The method also includes the UE deciding, based on the report configuration, whether or not to include in a report corresponding to the report configuration at least first rank information associated with at least a first spatial filter. The first rank information specifies a first maximum number of downlink, DL, and/or uplink, UL, spatial layers supported by the UE.

In some embodiments, receiving the report configuration comprises receiving a Radio Resource Control, RRC, message containing the report configuration.

In some embodiments the method also includes the UE determining the first rank information, wherein the first rank information is determined based on an antenna arrangement used to receive a reference signal, RS, transmitted using the first spatial filter.

In another embodiment the method performed by the UE includes the UE receiving a first reference signal, RS, transmitted by a network node using a first spatial filter and transmitting to the network node a report, the report comprising first rank information associated with at least the first spatial filter. The first rank information specifies a first maximum number of DL and/or UL spatial layers supported by the UE, and the report further comprises a first measurement value associated with the first spatial filter.

In some embodiments the method also includes the UE determining the first rank information, wherein the first rank information is determined based on the antenna arrangement used to receive the RS.

In some embodiments, the first rank information specifies a first maximum number of UL spatial layers supported by the UE.

In some embodiments the method also includes the UE receiving a second reference signal transmitted by the network node using a second spatial filter, wherein the report further comprises second rank information associated with the second spatial filter, but not the first spatial filter, wherein the second rank information specifies a second maximum number of DL and/or UL spatial layers supported by the UE.

In some embodiments, the report further comprises a second measurement value associated with the second spatial filter. In some embodiments, the first measurement value is a first reference signal received power, RSRP, value or a first signal-to-interference-plus-noise ratio, SINR, value, and the second measurement value is a second RSRP value or a second SINR value.

In some embodiments, the first reference signal is a first channel state information (CSI) reference signal (CSI-RS) or a first synchronization signal block (SSB), and the second reference signal is a second CSI-RS or a second SSB.

In some embodiments, the first reference signal is associated with a first CSI-RS resource indicator (CRI) or a first SSB resource indicator (SSBRI), the second reference signal is associated with a second CRI or a second SSBRI, the report further comprises i) the first CRI or the first SSBRI and ii) the second CRI or the second SSBRI.

In another aspect there is provided a method performed by a network node. In one embodiment the method includes the network node transmitting to a UE a report configuration, wherein the report configuration configures the UE such that when the UE transmits a report based on the report configuration, the UE includes in the report at least first rank information associated with at least a first spatial filter that was used to transmit a first RS wherein the first rank information specifies a first maximum number of DL and/or UL spatial layers supported by the UE.

In some embodiments, the first rank information specifies a first maximum number of UL spatial layers supported by the UE.

In some embodiments, the report configuration further configures the UE such that the UE further includes in the report a first measurement value associated with the first spatial filter.

In some embodiments, the method further comprises transmitting a second RS using a second spatial filter, the report configuration further configures the UE such that the UE further includes in the report second rank information associated with the second spatial filter, and the second rank information specifies a second maximum number of DL and/or UL spatial layers supported by the UE.

In another embodiment the method performed by the network node includes the network node transmitting a first reference signal using a first spatial filter. The method also includes the network node receiving a report transmitted by a UE. The report comprises first rank information associated with the first spatial filter and a first measurement value associated with the first spatial filter, and the first rank information specifies a first maximum number of DL and/or UL spatial layers supported by the UE.

In some embodiments, the method further comprises the network node transmitting a second reference signal using a second spatial filter, wherein the report further comprises second rank information associated with the second spatial filter, wherein the second rank information specifies a second maximum number of DL and/or UL spatial layers supported by the UE.

In some embodiments, the report further comprises a second measurement value associated with the second spatial filter. In some embodiments, the first measurement value is a first reference signal received power, RSRP, value or a first signal-to-interference-plus-noise ratio, SINR, value, and the second measurement value is a second RSRP value or a second SINR value.

In some embodiments, the first reference signal is a first channel state information, CSI, reference signal, CSI-RS or a first synchronization signal block, SSB, and the second reference signal is a second CSI-RS or a second SSB.

In some embodiments, the first reference signal is associated with a first CRI or a first SSBRI, the second reference signal is associated with a second CRI or a second SSBRI, and the report further comprises i) the first CRI or the first SSBRI and ii) the second CRI or the second SSBRI.

In some embodiments, the method further comprises the network node adapting a transmission to the UE based on rank information included in the report.

In some embodiments, the method further comprises the network node using rank information included in the report to select a spatial filter from a set of spatial filters that includes the first spatial filter and the second spatial filter.

In another aspect there is provided a computer program comprising instructions which when executed by processing circuitry of a UE causes the UE to perform any of the UE methods disclosed herein. In another aspect there is provided carrier containing the computer program, wherein the carrier is one of an electronic signal, an optical signal, a radio signal, and a computer readable storage medium.

In another aspect there is provided a computer program comprising instructions which when executed by processing circuitry of a network node causes the network node to perform any of the network node methods disclosed herein. In another aspect there is provided carrier containing the computer program, wherein the carrier is one of an electronic signal, an optical signal, a radio signal, and a computer readable storage medium.

In another aspect there is provided a UE. In one embodiment the UE is configured to receive a report configuration transmitted by a network node and decide, based on the report configuration, whether or not to include in a report corresponding to the report configuration at least first rank information associated with at least a first spatial filter. The first rank information specifies a first maximum number of downlink, DL, and/or uplink, UL, spatial layers supported by the UE.

In another embodiment the UE is configured to receive a first reference signal, RS, transmitted by a network node using a first spatial filter and transmitting to the network node a report, the report comprising first rank information associated with at least the first spatial filter. The first rank information specifies a first maximum number of DL and/or UL spatial layers supported by the UE, and the report further comprises a first measurement value associated with the first spatial filter.

In another aspect there is provided a network node. In one embodiment the network node is configured to transmit to a UE a report configuration, wherein the report configuration configures the UE such that when the UE transmits a report based on the report configuration, the UE includes in the report at least first rank information associated with at least a first spatial filter that was used to transmit a first RS wherein the first rank information specifies a first maximum number of DL and/or UL spatial layers supported by the UE.

In another embodiment the network node is configured to transmit a first reference signal using a first spatial filter. The method also includes the network node receiving a report transmitted by a UE. The report comprises first rank information associated with the first spatial filter and a first measurement value associated with the first spatial filter, and the first rank information specifies a first maximum number of DL and/or UL spatial layers supported by the UE.

The embodiments disclosed herein provide the advantage of enabling a network node (e.g., gNB) serving the UE to be aware of the supported DL and/or UL max rank associated with a reported beam. Based on this indicated rank, the network node could adapt the transmission/reception/scheduling of the UE (for example if maximum rank 1 is supported, the network node only need to trigger a single SRS port instead of two SRS port etc). In addition, because each reported beam also indicates a max rank (in addition to other metrics such as RSRP or SINR), the gNB can make a better decision of which beam to use in order to improve the spectral efficiency. For example, assume that the UE reports two beams (B1 and B2), and where B1 has RSRP=−100 dBm, and B2 has an RSRP of −102 dBm. In this case, the gNB would typically select B1 for transmission/reception with the UE since it was best for the reported metric (RSRP). However, in case max rank also is reported per beam, and max rank for B1 is reported to be 1 and the max rank for B2 is reported to be 2, then it might be beneficial (based on e.g. spectral efficiency) to select B2 instead of B1 (since then maximum rank 2 can be utilized instead of maximum rank 1). This could also be useful for FR1, where the UE might want/need to turn off TX/RX chains to save power, and then (based on the maximum rank reporting) inform the network node that the max rank is temporarily lower than the max rank UE reported as a capability, so that the network node can schedule UL/DL data with the correct rank.

### BRIEF DESCRIPTION OF THE DRAWINGS

The accompanying drawings, which are incorporated herein and form part of the specification, illustrate various embodiments.

FIG. 1 illustrates typical data scheduling in NR.

FIG. 2 illustrates slot durations at different subcarrier spacing.

FIG. 3 illustrates an example physical time-frequency resource grid.

FIG. 4 illustrates the SSB structure.

FIG. 5A illustrates one SSB that covers the whole cell.

FIG. 5B illustrates several beamformed SSBs being used to attain coverage over the whole cell.

FIG. 6 illustrates example beam pairs.

FIG. 7 illustrates a beam management procedure.

FIG. 8 illustrates a structure of a MAC CE.

FIG. 9 illustrates Semi-Persistent CSI-RS Transmission.

FIG. 10 illustrates a UE having multiple antenna panels pointing in different directions.

FIG. 11 illustrates a UE connecting TX chains to one panel and RX chains to another panel.

FIG. 12 is a message flow diagram illustrating communication between a UE and a network node according to some embodiments.

FIG. 13 is a flow chart illustrating a process according to some embodiments.

FIG. 14 is a flow chart illustrating a process according to some embodiments.

FIG. 15 is a flow chart illustrating a process according to some embodiments.

FIG. 16 is a flow chart illustrating a process according to some embodiments.

FIG. 17 is a flow chart illustrating a process according to some embodiments.

FIG. 18 is a flow chart illustrating a process according to some embodiments.

FIG. 19 is a flow chart illustrating a process according to some embodiments.

FIG. 20 is a block diagram illustrating a UE according to some embodiments.

FIG. 21 is a block diagram illustrating a network node according to some embodiments.

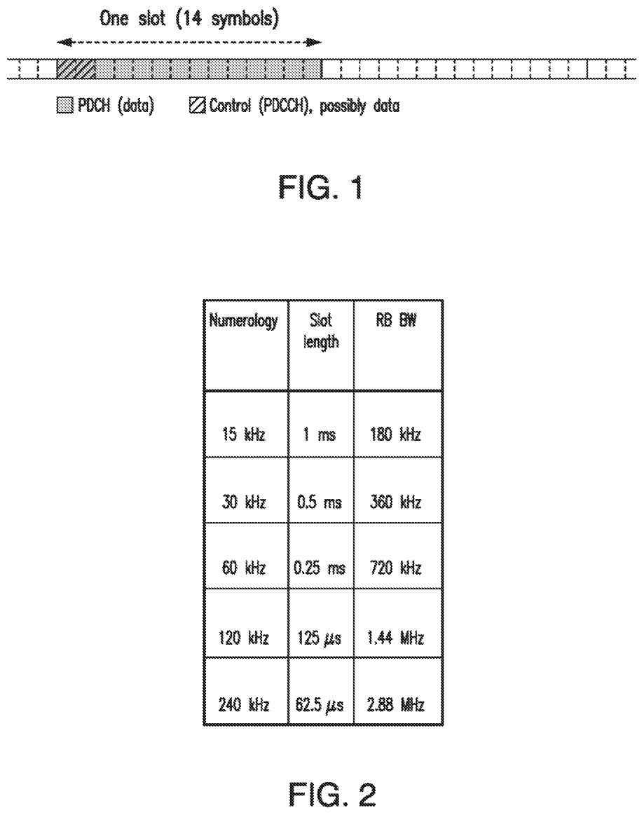

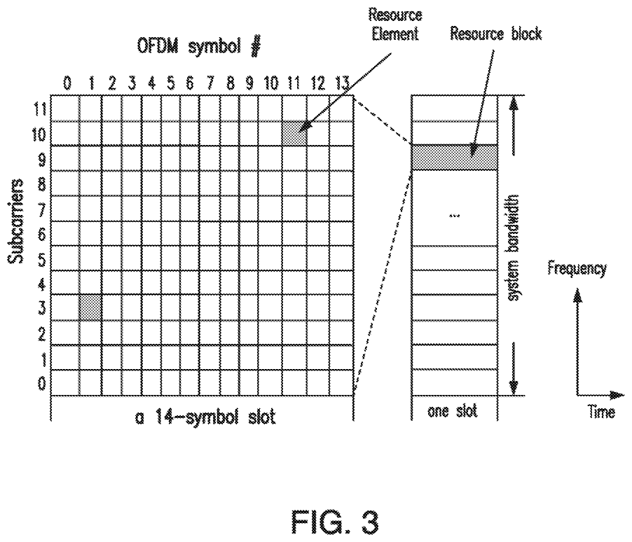

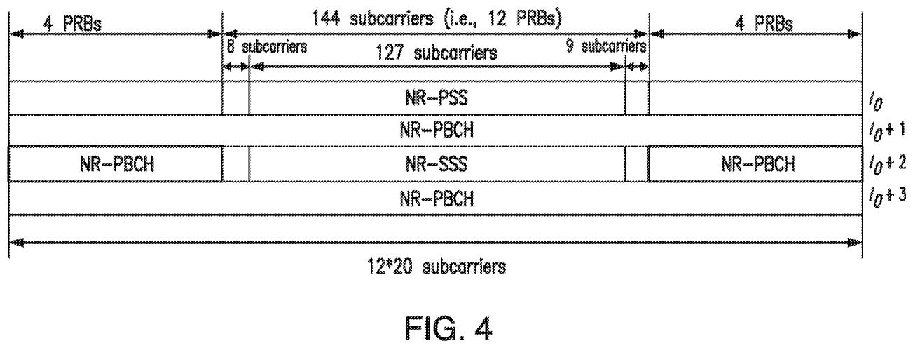

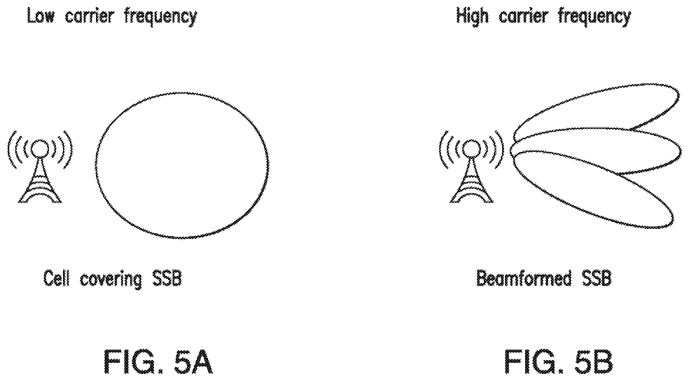

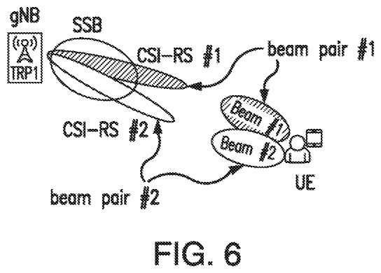

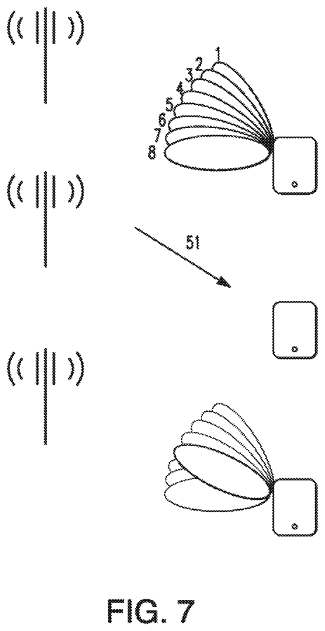

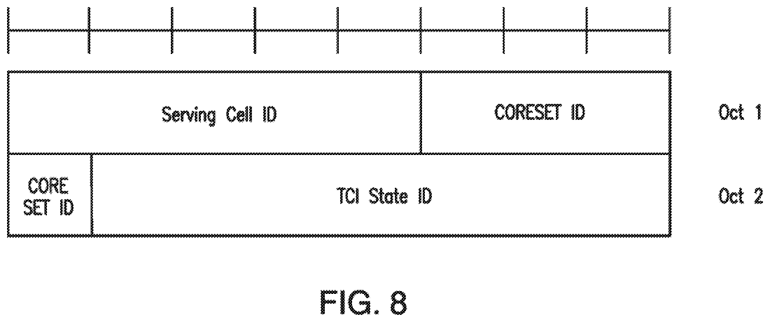

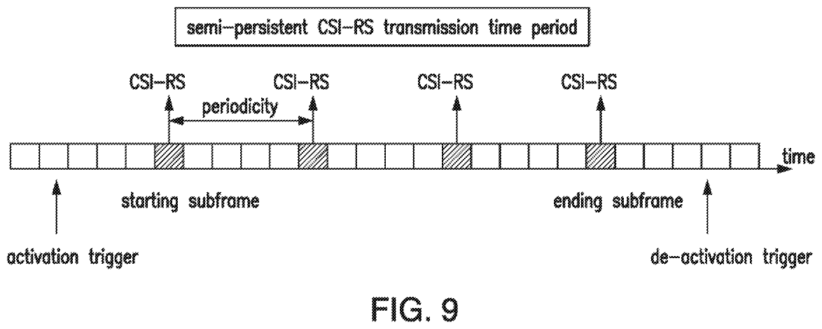

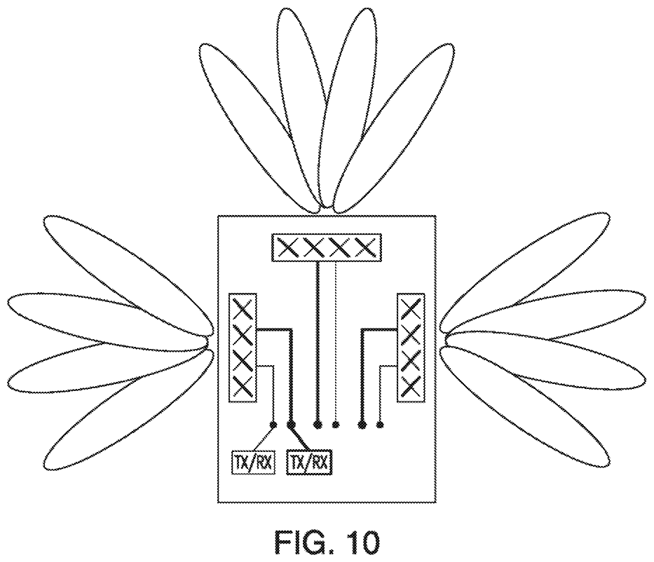

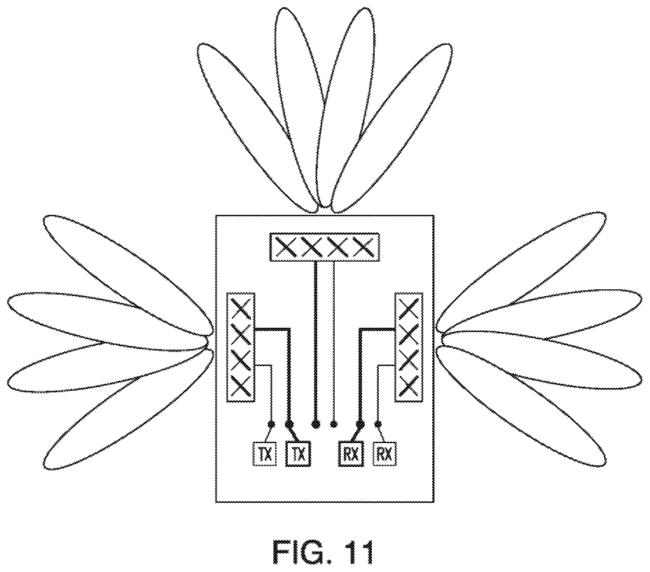

### DETAILED DESCRIPTION

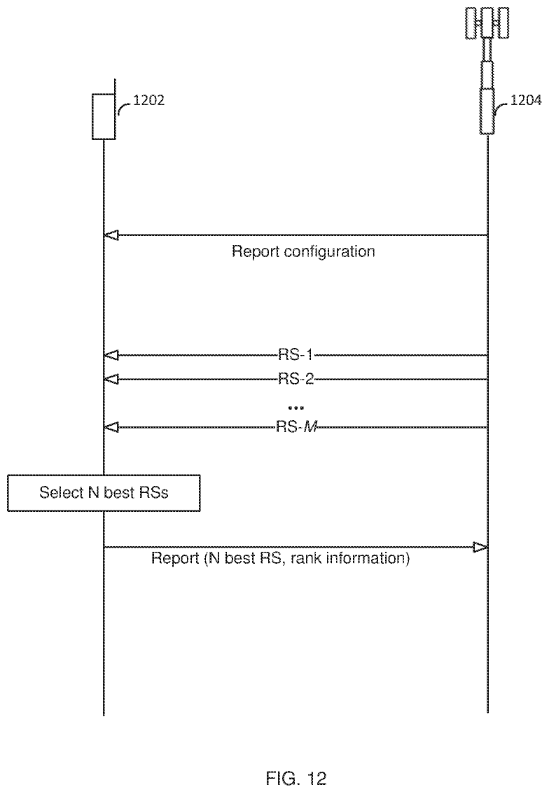

FIG. 12 is a message flow diagram illustrating communications between a UE 1202 and a network node of an access network 1204 (e.g., a 5G base station (gNB)). As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

In one embodiment, as shown in FIG. 12, network node 1204 transmits to UE 1202 report configuration (e.g., CSI Report Configuration). In one embodiment, the network node transmits the report configuration to the UE by transmitting to the UE an RRC message that contains the report configuration.

In one embodiment, the report configuration specifies that when the UE transmits a report corresponding to the report configuration, the UE should include in the report at least first rank information indicating a max UL rank and/or max DL rank (i.e., the first rank information indicates a maximum number of layers supported by the UE for DL and/or UL). The first rank information may be associated with only a single beam (CRI or SSBRI) or it may be associated with multiple beams.

After transmitting the report configuration, as shown in FIG. 12, the network node may transmit multiple beamformed reference signals. That is, for example, the network node may use M different transmit (Tx) beams to transmit M reference signals (one reference signal per Tx beam). Each reference signal (RS) is associated with a CRI or SSBRI that identifies the resource (e.g., time/frequency resource) used to transmit the RS. The UE then measures each reference signal to produce a measurement result (e.g., the UE calculates the Reference Signal Received Power (RSRP) for each reference signal or SINR) and then sends to the network node a report based on the report configuration. In one embodiment, the report identifies the N best reference signals and indicates the RSRP value (or other measurement result) for each of the N best reference signals. In one embodiment, the UE identifies a reference signal by including in the report the CRI or SSBRI for the reference signal. Because the network node keeps a mapping between the beam used to transmit a reference signal and the CRI/SSBRI for the reference signal, the network node can determine the best N transmit beams (spatial transmit filters).

In one embodiment, a single DL and/or UL maximum rank is indicated per report (other metrics as for example DL RSRP, RI, CQI etc also could be included in the report). In an alternate embodiment, one DL and/or UL maximum rank is indicated per beam in the report (note that other metrics as for example DL RSRP/UL RSRP SINR etc also could be included in the report, e.g. per reported beam).

In one embodiment, only maximum DL rank is indicated (per report or per beam in the report). In one embodiment, only maximum UL rank is indicated (per report or per beam in the report). In one embodiment, a common maximum rank is indicated for both DL and UL (per report or per beam in the report). In one embodiment, one DL maximum rank and one UL maximum rank is indicated (per report or per beam in the report).

The tables below illustrates a schematic example of how CSI fields can look for two different new report quantities, one report quantity where the maximum rank is signaled per report (upper table), and one report quantity where the maximum rank is signaled per reported beam in the report (lower table). The tables are extensions of the CSI field tables defined in 3GPP TS 38.212 V16.6.0 (hereafter “TS 38.212”) for the report quantities “cri-RSRP” and “ssb-Index-RSRP”,

| CSI Report | |
|---|---|
| Number | CSI Fields |
| CSI report #n | CRI or SSBRI #1 as in Table 6.3.1.1.2-6, if reported |
| | CRI or SSBRI #2 as in Table 6.3.1.1.2-6, if reported |
| | CRI or SSBRI #3 as in Table 6.3.1.1.2-6, if reported |
| | CRI or SSBRI #4 as in Table 6.3.1.1.2-6, if reported |
| | RSRP #1 as in Table 6.3.1.1.2-6, if reported |
| | Differential RSRP #2 as in Table 6.3.1.1.2-6, if reported |
| | Differential RSRP #3 as in Table 6.3.1.1.2-6, if reported |
| | Differential RSRP #4 as in Table 6.3.1.1.2-6, if reported |
| | Maximum DL and/or UL rank, if reported |

| CSI Report | |
|---|---|
| Number | CSI Fields |
| CSI report #n | CRI or SSBRI #1 as in Table 6.3.1.1.2-6, if reported |
| | CRI or SSBRI #2 as in Table 6.3.1.1.2-6, if reported |
| | CRI or SSBRI #3 as in Table 6.3.1.1.2-6, if reported |
| | CRI or SSBRI #4 as in Table 6.3.1.1.2-6, if reported |
| | RSRP #1 as in Table 6.3.1.1.2-6, if reported |
| | Differential RSRP #2 as in Table 6.3.1.1.2-6, if reported |
| | Differential RSRP #3 as in Table 6.3.1.1.2-6, if reported |
| | Differential RSRP #4 as in Table 6.3.1.1.2-6, if reported |
| | Maximum DL and/or UL rank #1, if reported |
| | Maximum DL and/or UL rank #2, if reported |
| | Maximum DL and/or UL rank #3, if reported |
| | Maximum DL and/or UL rank #4, if reported |

One example of how such new report quantities can be RRC configured could be seen in the table below, both for CSI-RS and for SSB. In this example, it is assumed that the UE will report N CRIs/SSBRIs with highest RSRP, an RSRP value (either absolute and/or relative RSRP) for each reported CRI/SSBRI and a DL and/or UL maximum rank (per report or per reported CRI/SSBRI). The table below shows that two new elements are added to the “reportQuanity” element of the CSI Report Configuration information element as defined in TS 38.331.

CSI-ReportConfig ::= SEQUENCE {

| | |
|---|---|
| reportConfigId | CSI-ReportConfigId, |
| carrier | ServCellIndex |
| resourcesForChannelMeasurement | CSI-ResourceConfigId, |

...

| | |
|---|---|
| reportQuantity | CHOICE { |
| none | NULL, |
| cri-RI-PMI-CQI | NULL, |
| cri-RI-il | NULL, |
| cri-RI-il-CQI | SEQUENCE { |
| pdsch-BundleSizeForCSI | ENUMERATED {n2, n4} |

},

| | |
|---|---|
| cri-RI-CQI | NULL, |
| cri-RSRP | NULL, |
| ssb-Index-RSRP | NULL, |
| cri-RI-LI-PMI-CQI | NULL, |
| cri-RSRP-MaxRank | NULL, |
| ssb-Index-RSRP-MaxRank | NULL |

},
...

In the examples above, the UE could be configured to either report one maximum DL and/or UL rank per report or one maximum DL and/or UL rank per reported beam. In case the UE uses the same UE panel for all DL-RS associated to the report, then, to save overheard, the UE reports only one maximum DL and/or UL rank value. However, in case the UE uses different UE panels for different DL-RS associated to the report, then the UE indicates one maximum DL and/or UL rank per reported beam. Which one to use (max rank per report or max rank per beam) could either be implicitly or explicitly signaled to the UE.

Implicit method: In case all the DL-RS associated to the beam report has the same TCI state, then it is likely that the UE would use the same panel to receive all the DL-RS, and hence it would make sense to indicate only one maximum DL and/or UL rank in the report. Hence, in one alternate of this embodiment, in case all the DL-RS associated to the report has the same TCI state, the UE only should report one maximum DL and/or UL rank applicable for the whole report, while in case at least two of the DL-RS associated to the report has different TCI states, the UE should report one maximum DL and/or UL rank per beam. Note that this only implies to CSI-RS, since SSB is not associated to a TCI states.

Explicit method: In one alternate of this embodiment, the UE can be RRC configured to report a maximum DL and/or UL rank per report or per beam. This could for example be RRC configured in a report setting, as exemplified in the table below (other examples are possible, for example there might be two parameters configured, one parameter for indicating if the UE should report maximum rank for DL and another parameter for indicating if the UE should report maximum rank for UL, and in that way, the UE can be configured with reporting maximum rank for none, DL only, UL only or both DL and UL):

CSI-ReportConfig ::= SEQUENCE {

| | |
|---|---|
| reportConfigId | CSI-ReportConfigId, |
| carrier | ServCellIndex |
| resourcesForChannelMeasurement | CSI-ResourceConfigId, |

...

| | |
|---|---|
| reportQuantity | CHOICE { |
| none | NULL, |
| cri-RI-PMI-CQI | NULL, |
| cri-RI-il | NULL, |
| cri-RI-il-CQI | SEQUENCE { |
| pdsch-BundleSizeForCSI | ENUMERATED {n2, n4} |

},

| | |
|---|---|
| cri-RI-CQI | NULL, |
| cri-RSRP | NULL, |
| ssb-Index-RSRP | NULL, |
| cri-RI-LI-PMI-CQI | NULL, |
| cri-RSRP-MaxRank | Sequence { |
| MaxRankPerBeam | Enumerated {on, Off} |

},

| | |
|---|---|
| ssb-Index-RSRP-MaxRank | Sequence { |
| MaxRankPerBeam | Enumerated {on, Off} |

```
    }
  },
...
```

Reporting of UL/DL max rank for simultaneous reception/transmission from multiple UE antenna panels:

In one embodiment, a UE may be configured to report group based beam reporting for receiving up to N beam groups. In NR Rel-17, the value of N can be 1, 2, 3, or 4 (i.e., the UE can be configured to report up to 4 beam groups in a beam report). Each beam group consists of 2 beams wherein the 2 beams within each beam group can be received simultaneously by a UE using different UE panels. The 2 beams may also be used to simultaneously transmit to two different beam directions using different UE panels. For example, assume the UE reports the following beam groups as part of a report:
Beam group 1: CRI A, CRI S
Beam group 2: CRI B, CRI T
Beam group 3: CRI C, CRI U
Beam group 4: CRI D, CRI V

In one embodiment, the two CRIs corresponding to each beam group are received using different UE panels. Hence, in this embodiment, a pair of maximum DL and/or UL ranks are reported per beam group. For example, two maximum DL ranks are reported for beam group 1, where the first maximum DL rank corresponds to the panel that is used to receive CRI A, and the second maximum DL rank corresponds to the panel that is used to receive CRI S. Similarly, two maximum UL ranks are reported for beam group 1, where the first maximum UL rank corresponds to the panel that is used to receive CRI A, and the second maximum UL rank corresponds to the panel that is used to receive CRI S.

In some embodiments, when the UE is equipped with more than two panels, beam groups 1 and 2 may be received using panels 1 and 2 of the UE, while beam groups 3 and 4 may be received using panels 3 and 4 of the UE. For instance, CRIs A and B are received using panel 1, CRIs S and T are received using panel 2. CRIs C and D are received using panel 3 and CRIs U and V are received using panel 4. In this embodiment, a pair of maximum DL and/or UL ranks are reported per N′>1 beam groups reported. Hence, in this embodiment, we have the following:
1) two maximum DL ranks are reported for beam groups 1 and 2, where the first maximum DL rank corresponds to the panel that is used to receive CRIs A and B, and the second maximum DL rank corresponds to the panel that is used to receive CRIs S and T.
2) two maximum UL ranks are reported for beam groups 1 and 2, where the first maximum UL rank corresponds to the panel that is used to receive CRIs A and B, and the second maximum UL rank corresponds to the panel that is used to receive CRIs S and T.
3) two maximum DL ranks are reported for beam groups 3 and 4, where the first maximum DL rank corresponds to the panel that is used to receive CRIs C and D, and the second maximum DL rank corresponds to the panel that is used to receive CRIs U and V.
4) two maximum UL ranks are reported for beam groups 3 and 4, where the first maximum UL rank corresponds to the panel that is used to receive CRIs C and D, and the second maximum UL rank corresponds to the panel that is used to receive CRIs U and V.

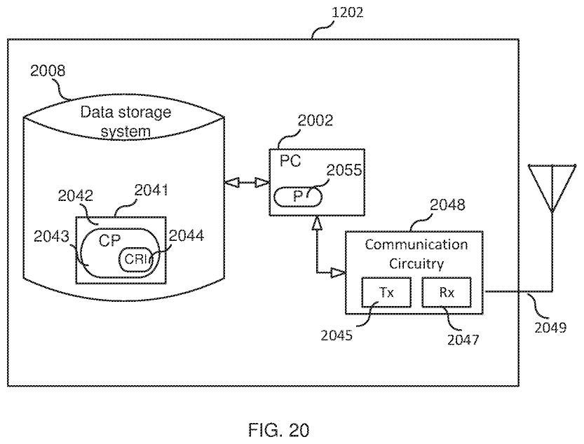

FIG. 20 is a block diagram of UE 1202, according to some embodiments. As shown in FIG. 20, UE 1202 may comprise: processing circuitry (PC) 2002, which may include one or more processors (P) 2055 (e.g., one or more general purpose microprocessors and/or one or more other processors, such as an application specific integrated circuit (ASIC), field-programmable gate arrays (FPGAs), and the like); communication circuitry 2048, which is coupled to an antenna arrangement 2049 comprising one or more antennas and which comprises a transmitter (Tx) 2045 and a receiver (Rx) 2047 for enabling UE 1202 to transmit data and receive data (e.g., wirelessly transmit/receive data); and a local storage unit (a.k.a., “data storage system”) 2008, which may include one or more non-volatile storage devices and/or one or more volatile storage devices. In embodiments where PC 2002 includes a programmable processor, a computer program product (CPP) 2041 may be provided. CPP 2041 includes a computer readable medium (CRM) 2042 storing a computer program (CP) 2043 comprising computer readable instructions (CRI) 2044. CRM 2042 may be a non-transitory computer readable medium, such as, magnetic media (e.g., a hard disk), optical media, memory devices (e.g., random access memory, flash memory), and the like. In some embodiments, the CRI 2044 of computer program 2043 is configured such that when executed by PC 2002, the CRI causes UE 1202 to perform steps described herein (e.g., steps described herein with reference to the flow charts). In other embodiments, UE 1202 may be configured to perform steps described herein without the need for code. That is, for example, PC 2002 may consist merely of one or more ASICs. Hence, the features of the embodiments described herein may be implemented in hardware and/or software

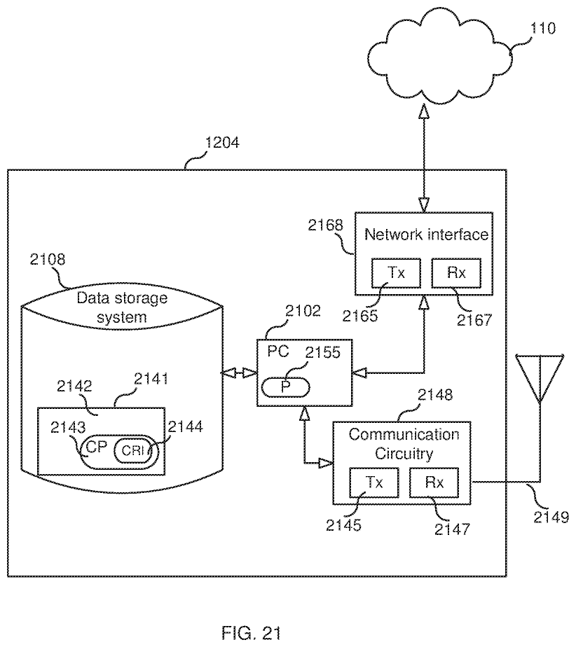

FIG. 21 is a block diagram of network node 1204, according to some embodiments for performing the network node methods disclosed herein. As shown in FIG. 21, network node 1204 may comprise: processing circuitry (PC) 2102, which may include one or more processors (P) 2155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., the network node may be a distributed computing apparatus); a network interface 2168 comprising a transmitter (Tx) 2165 and a receiver (Rx) 2167 for enabling network node 1204 to transmit data to and receive data from other nodes connected to a network 110 (e.g., an Internet Protocol (IP) network) to which network interface 2168 is connected; communication circuitry 2148 (e.g., radio transceiver circuitry comprising an Rx 2147 and a Tx 2145) coupled to an antenna system 2149 for wireless communication with UEs or other nodes); and a local storage unit (a.k.a., “data storage system”) 2108, which may include one or more non-volatile storage devices and/or one or more volatile storage devices. In embodiments where PC 2102 includes a programmable processor, a computer program product (CPP) 2141 may be provided. CPP 2141 includes a computer readable medium (CRM) 2142 storing a computer program (CP) 2143 comprising computer readable instructions (CRI) 2144. CRM 2142 may be a non-transitory computer readable medium, such as, magnetic media (e.g., a hard disk), optical media, memory devices (e.g., random access memory, flash memory), and the like. In some embodiments, the CRI 2144 of computer program 2143 is configured such that when executed by PC 2102, the CRI causes network node 1204 to perform steps described herein (e.g., steps described herein with reference to one or more flow charts). In other embodiments, network node 1204 may be configured to perform steps described herein without the need for code. That is, for example, PC 2102 may consist merely of one or more ASICs. Hence, the features of the embodiments described herein may be implemented in hardware and/or software.

### Summary of Various Embodiments

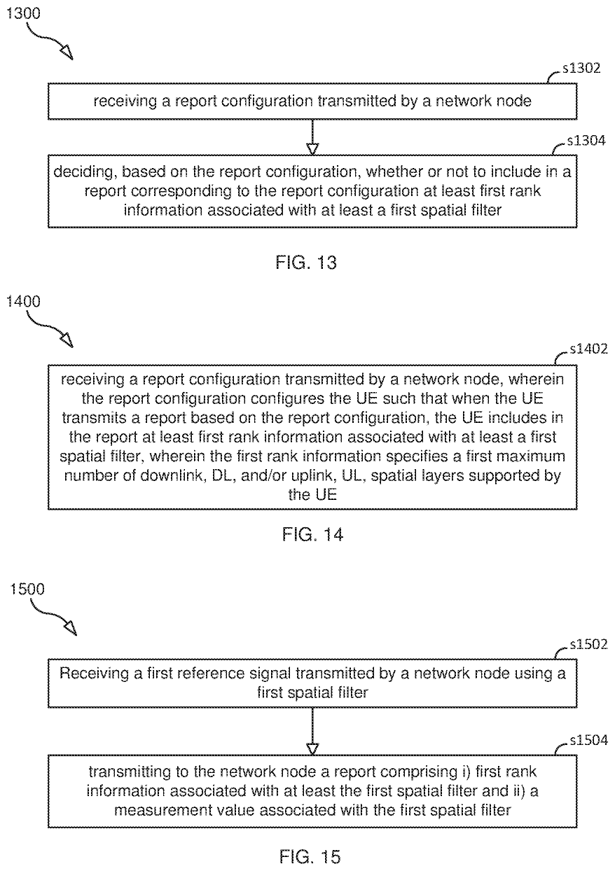

A1a. A method 1300 (see FIG. 13) performed by a UE, the method comprising: receiving a report configuration transmitted by a network node (see step s1302 of FIG. 13); and deciding, based on the report configuration, whether or not to include in a report corresponding to the report configuration at least first rank information associated with at least a first spatial filter, wherein the first rank information specifies a first maximum number of downlink, DL, and/or uplink, UL, spatial layers supported by the UE (see step s1304 of FIG. 13).

A1b. A method 1400 (see FIG. 14) performed by a UE, the method comprising: receiving a report configuration transmitted by a network node (see step s1402 of FIG. 14), wherein the report configuration configures the UE such that when the UE transmits a report based on the report configuration, the UE includes in the report at least first rank information associated with at least a first spatial filter, wherein the first rank information specifies a first maximum number of downlink, DL, and/or uplink, UL, spatial layers supported by the UE.

A2. The method of embodiment A1a or A1b, wherein receiving the report configuration comprising receiving a Radio Resource Control (RRC) message containing the report configuration.

A3. The method of any one of the above embodiments, further comprising determining the first rank information, wherein the first rank information is determined based on an antenna arrangement used to receive a RS transmitted using the first spatial filter.

B1a. A method 1500 (see FIG. 15) performed by a UE, the method comprising: receiving a first reference signal transmitted by a network node using a first spatial filter (a.k.a., “beam”) (see step s1502 of FIG. 15); and transmitting to the network node a report (e.g., a channel state information, CSI, report) comprising i) first rank information associated with at least the first spatial filter, wherein the first rank information specifies a first maximum number of downlink, DL, and/or uplink, UL, spatial layers supported by the UE and ii) a measurement value (e.g., RSRP, SINR, differential RSRP, etc.) associated with the first spatial filter (see step S1504 of FIG. 15).

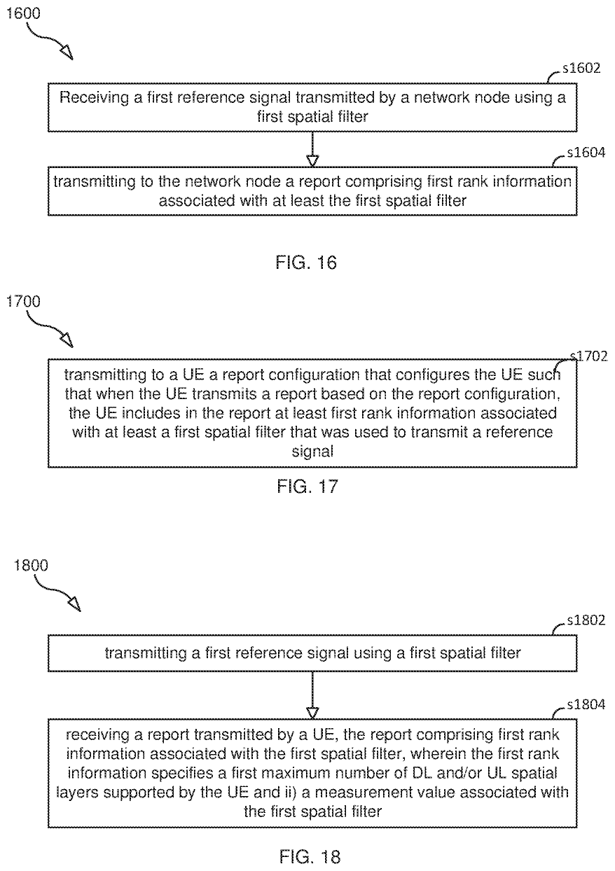

B1b. A method 1600 (see FIG. 16) performed by a UE, the method comprising: receiving a first reference signal transmitted by a network node using a first spatial filter (see step s1602 of FIG. 16); and transmitting to the network node a report (e.g., a channel state information, CSI, report) comprising first rank information associated with at least the first spatial filter, wherein the first rank information specifies a first maximum number of uplink, UL, spatial layers supported by the UE (see step s1604 of FIG. 16).

B2. The method of embodiment B1b, wherein the report further comprises a measurement value (e.g., RSRP, SINR, differential RSRP, etc.) associated with the first spatial filter.

B3. The method of embodiment B1a, B1b, or B2, further comprising determining the first rank information, wherein the first rank information is determined based on the antenna arrangement used to receive the RS (e.g. number of available tx or rx chains).

B4. The method of any one of embodiments B1a or B3 when dependent on B1a, wherein the first rank information specifies a first maximum number of UL spatial layers supported by the UE.

B5. The method of any one of embodiments B1a or B3 when dependent on B1a, wherein the first rank information specifies a first maximum number of DL spatial layers supported by the UE. B6. The method of any one of embodiments B1a, B1b, B2, or B3, wherein the first rank information specifies both a first maximum number of DL spatial layers supported by the UE and a first maximum number of UL spatial layers supported by the UE.

B7. The method of any one of embodiments B1a, B1b, or B2-B6, further comprising determining second rank information associated with the first spatial filter, wherein the first rank information specifies a first maximum number of UL spatial layers supported by the UE, the second rank information specifies a first maximum number of DL spatial layers supported by the UE, and the report further comprises the second rank information.

B8. The method of any one of embodiments B1a, B1b, or B2-B6, further comprising: receiving a second reference signal transmitted by the network node using a second spatial filter, wherein the report further comprises second rank information associated with the second spatial filter, but not the first spatial filter, wherein the second rank information specifies a second maximum number of DL and/or UL spatial layers supported by the UE.

C1. A method 1700 (see FIG. 17) performed by a network node, the method comprising: transmitting to a UE a report configuration, wherein the report configuration configures the UE such that when the UE transmits a report based on the report configuration, the UE includes in the report at least first rank information associated with at least a first spatial filter that was used to transmit a reference signal, wherein the first rank information specifies a first maximum number of downlink, DL, and/or uplink, UL, spatial layers supported by the UE (see step s1702 of FIG. 17).

D1a. A method 1800 (see FIG. 18) performed by a network node, the method comprising: transmitting a first reference signal using a first spatial filter (see step s1802 of FIG. 18); and receiving a report transmitted by a UE, wherein the report comprises first rank information associated with the first spatial filter, wherein the first rank information specifies a first maximum number of downlink, DL, and/or uplink, UL, spatial layers supported by the UE and ii) a measurement value (e.g., RSRP, SINR, differential RSRP, etc.) associated with the first spatial filter (see step s1804 of FIG. 18).

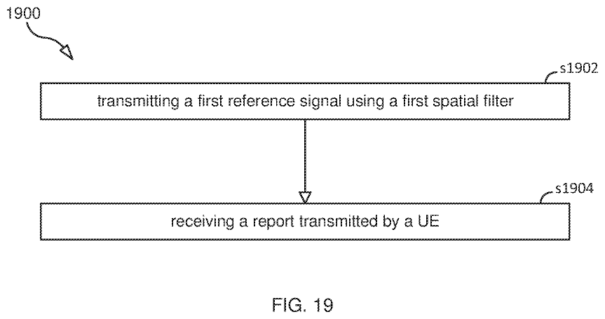

D1b. A method 1900 (see FIG. 19) performed by a network node, the method comprising: transmitting a first reference signal using a first spatial filter (see step s1902 of FIG. 19); and receiving a report transmitted by a UE (see step s1904 of FIG. 19), wherein the report comprises first rank information associated with the first spatial filter, wherein the first rank information specifies a first maximum number of uplink, UL, spatial layers supported by the UE.

D2. The method of embodiment D1b, wherein the report further comprises a measurement value (e.g., RSRP, SINR, differential RSRP, etc.) associated with the first spatial filter.

D3. The method of embodiment D1a, wherein the first rank information specifies a first maximum number of UL spatial layers supported by the UE.

D4. The method of embodiment D1a, wherein the first rank information specifies a first maximum number of DL spatial layers supported by the UE.

D5. The method of any one of embodiments D1a, D1b, or D2, wherein the first rank information specifies both a first maximum number of DL spatial layers supported by the UE and a first maximum number of UL spatial layers supported by the UE.

D6. The method of any one of embodiments D1a, D1b, or D2-D5, further comprising: transmitting a second reference signal using a second spatial filter, wherein the report further comprises second rank information associated with the second spatial filter, wherein the second rank information specifies a second maximum number of downlink, DL, and/or uplink, UL, spatial layers supported by the UE.

D7. The method of any one of embodiments D1a, D1b, or D2-D6, further comprising the network node adapting a transmission to the UE based on rank information included in the report.

D8. The method of any one of embodiments D1a, D1b, or D2-D7, further comprising the network node using rank information included in the report to select a spatial filter from a set of spatial filters that includes the first spatial filter and the second spatial filter.

E1. A computer program comprising instructions which when executed by processing circuitry of a UE causes the UE to perform the method of any one of above UE embodiments.

E2. A carrier containing the computer program of embodiment E1, wherein the carrier is one of an electronic signal, an optical signal, a radio signal, and a computer readable storage medium.

F1. A computer program comprising instructions which when executed by processing circuitry of a network node causes the network node to perform the method of any one of the above network node embodiments.

F2. A carrier containing the computer program of embodiment F1, wherein the carrier is one of an electronic signal, an optical signal, a radio signal, and a computer readable storage medium.

G1a. A user equipment, UE, the UE being configured to: receive a report configuration transmitted by a network node; and decide, based on the report configuration, whether or not to include in a report corresponding to the report configuration at least first rank information associated with at least a first spatial filter, wherein the first rank information specifies a first maximum number of downlink, DL, and/or uplink, UL, spatial layers supported by the UE.

G1b. A UE, the UE being configured to: receive a report configuration transmitted by a network node, wherein the report configuration configures the UE such that when the UE transmits a report based on the report configuration, the UE includes in the report at least first rank information associated with at least a first spatial filter, wherein the first rank information specifies a first maximum number of downlink, DL, and/or uplink, UL, spatial layers supported by the UE.

G2. The UE of embodiment G1a or G1b, wherein receiving the report configuration comprising receiving a Radio Resource Control (RRC) message containing the report configuration.

G3. The UE of any one of the above embodiments, further comprising determining the first rank information, wherein the first rank information is determined based on an antenna arrangement used to receive a RS transmitted using the first spatial filter.

H1a. A UE, the UE being configured to: receive a first reference signal transmitted by a network node using a first spatial filter; and transmit to the network node a report (e.g., a channel state information, CSI, report) comprising i) first rank information associated with at least the first spatial filter, wherein the first rank information specifies a first maximum number of downlink, DL, and/or uplink, UL, spatial layers supported by the UE and ii) a measurement value (e.g., RSRP, SINR, differential RSRP, etc.) associated with the first spatial filter.

H1b. A UE, the UE being configured to: receive a first reference signal transmitted by a network node using a first spatial filter; and transmit to the network node a report (e.g., a channel state information, CSI, report) comprising first rank information associated with at least the first spatial filter, wherein the first rank information specifies a first maximum number of uplink, UL, spatial layers supported by the UE.

H2. The UE of embodiment H1b, wherein the report further comprises a measurement value (e.g., RSRP, SINR, differential RSRP, etc.) associated with the first spatial filter.

H3. The UE of embodiment H1a, H1b, or H2, wherein the UE is further configured to determine the first rank information, wherein the first rank information is determined based on the antenna arrangement used to receive the RS (e.g. number of available tx or rx chains).

H4. The UE of any one of embodiments Hla or H3 when dependent on H1a, wherein the first rank information specifies a first maximum number of UL spatial layers supported by the UE.

H5. The UE of any one of embodiments H1a or H3 when dependent on H1a, wherein the first rank information specifies a first maximum number of DL spatial layers supported by the UE.

H6. The UE of any one of embodiments H1a, H1b, H2, or H3, wherein the first rank information specifies both a first maximum number of DL spatial layers supported by the UE and a first maximum number of UL spatial layers supported by the UE.

H7. The UE of any one of embodiments H1a, H1b, or H2-H6, wherein the UE is further configured to determine second rank information associated with the first spatial filter, wherein the first rank information specifies a first maximum number of UL spatial layers supported by the UE, the second rank information specifies a first maximum number of DL spatial layers supported by the UE, and the report further comprises the second rank information.

H8. The UE of any one of embodiments H1a, H1b, or H2-H6, wherein the UE is further configured to: receive a second reference signal transmitted by the network node using a second spatial filter, wherein the report further comprises second rank information associated with the second spatial filter, but not the first spatial filter, wherein the second rank information specifies a second maximum number of DL and/or UL spatial layers supported by the UE.

I1. A network node, the network node being configured to: transmit to a UE a report configuration, wherein the report configuration configures the UE such that when the UE transmits a report based on the report configuration, the UE includes in the report at least first rank information associated with at least a first spatial filter that was used to transmit a reference signal, wherein the first rank information specifies a first maximum number of downlink, DL, and/or uplink, UL, spatial layers supported by the UE.

J1a. A network node, the network node being configured to: transmit a first reference signal using a first spatial filter; receive a report transmitted by a UE, wherein the report comprises first rank information associated with the first spatial filter, wherein the first rank information specifies a first maximum number of downlink, DL, and/or uplink, UL, spatial layers supported by the UE and ii) a measurement value (e.g., RSRP, SINR, differential RSRP, etc.) associated with the first spatial filter.

J1b. A network node, the network node being configured to: transmit a first reference signal using a first spatial filter; and receive a report transmitted by a UE, wherein the report comprises first rank information associated with the first spatial filter, wherein the first rank information specifies a first maximum number of uplink, UL, spatial layers supported by the UE.

J2. The network node of embodiment J1b, wherein the report further comprises a measurement value (e.g., RSRP, SINR, differential RSRP, etc.) associated with the first spatial filter.

J3. The network node of embodiment J1a, wherein the first rank information specifies a first maximum number of UL spatial layers supported by the UE.

J4. The network node of embodiment J1a, wherein the first rank information specifies a first maximum number of DL spatial layers supported by the UE.

J5. The network node of any one of embodiments J1a, J1b, or J2, wherein the first rank information specifies both a first maximum number of DL spatial layers supported by the UE and a first maximum number of UL spatial layers supported by the UE.

J6. The network node of any one of embodiments J1a, J1b, or J2-J5, further comprising: transmitting a second reference signal using a second spatial filter, wherein the report further comprises second rank information associated with the second spatial filter, wherein the second rank information specifies a second maximum number of downlink, DL, and/or uplink, UL, spatial layers supported by the UE.

J7. The network node of any one of embodiments J1a, J1b, or J2-J6, further comprising the network node adapting a transmission to the UE based on rank information included in the report.

J8. The network node of any one of embodiments J1a, J1b, or J2-J7, further comprising the network node using rank information included in the report to select a spatial filter from a set of spatial filters that includes the first spatial filter and the second spatial filter.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

3GPP Third Generation Partnership Project
ASN Abstract Syntax Notation
CE Control Element
CRI CSI-RS Resource Indicator
CSI Channel State Information
CSI-RS Channel State Information Reference Signal
DCI Downlink Control Information
DL Downlink
FR2 Frequency Range 2
gNB gNodeB
LTE Long Term Evolution
MAC Medium Access Control
MPE Maximum Permissible Exposure
MIMO Multiple-Input Multiple-Output
MCS Modulation and Coding Scheme
NR New Radio
OFDM Orthogonal Frequency-Division Multiplexing
PC Power Control
PDCCH Physical Downlink Control Channel
PUSCH Physical Uplink Shared Channel
RB Resource Block
RRC Radio Resource Control
RS Reference Signal
RSRP Reference Signal Received Power
SINR Signal-to-interference-plus-noise ratio
SRS Sounding Reference Signal
SSB Synchronization Signal Block
SSBRI SS/PBCH Resource Block Indicator
UE User Equipment
UL Uplink

1-50. (canceled)

51. A method performed by a user equipment, the method comprising:
receiving a first channel state information (CSI) reference signal (CSI-RS) from a network node; and
transmitting to the network node a CSI report, the CSI report comprising first rank information associated with at least the first CSI reference signal, wherein
the first rank information specifies a first maximum number of downlink (DL) and/or uplink (UL) spatial layers supported by the UE, and
the CSI report further comprises a first measurement value associated with the first received CSI reference signal.

52. The method of claim 51, wherein the method further comprises determining the first rank information based on an antenna arrangement used to receive the CSI-RS.

53. The method of claim 51, wherein the first rank information specifies a first maximum number of UL spatial layers supported by the UE.

54. The method of claim 51, wherein
the method further comprises receiving a second CSI reference signal from,
the CSI report further comprises second rank information associated with the second CSI reference signal, but not the first CSI reference signal, and
the second rank information specifies a second maximum number of DL and/or UL spatial layers supported by the UE.

55. The method of claim 54, wherein the CSI report further comprises a second measurement value associated with the second CSI reference signal.

56. The method of claim 55, wherein
the first measurement value is a first reference signal received power (RSRP) value or a first signal-to-interference-plus-noise ratio (SINR) value, and
the second measurement value is a second RSRP value or a second SINR value.

57. The method of claim 54, wherein
the first CSI reference signal is associated with a first CSI-RS resource indicator (CRI),
the second reference signal is associated with a second CRI,
the CSI report further comprises the first CRI and the second CRI.

58. The method of claim 51, wherein the method further comprises receiving from the network node a CSI report configuration for configuring the UE to include the first rank information in the CSI report.

59. A method performed by a network node, the method comprising:
transmitting a first channel state information (CSI) reference signal (CSI-RS); and
receiving a CSI report from a user equipment (UE), wherein
the CSI report comprises first rank information associated with the first CSI reference signal and a first measurement value associated with the first CSI reference signal, and
the first rank information specifies a first maximum number of downlink (DL) and/or uplink (UL) spatial layers supported by the UE.

60. The method of claim 59, wherein
the method further comprises transmitting a second CSI reference signal,
the CSI report further comprises second rank information associated with the second CSI reference signal, and
the second rank information specifies a second maximum number of DL and/or UL spatial layers supported by the UE.

61. The method of claim 60, wherein the CSI report further comprises a second measurement value associated with the second CSI reference signal.

62. The method of claim 61, wherein
the first measurement value is a first reference signal received power (RSRP) value or a first signal-to-interference-plus-noise ratio (SINR) value, and
the second measurement value is a second RSRP value or a second SINR value.

63. The method of claim 60, wherein
the first CSI reference signal is associated with a first CSI-RS resource indicator (CRI),
the second reference signal is associated with a second CRI, and
the CSI report further comprises the first CRI and the second CRI.

64. The method of claim 59, wherein the method further comprises transmitting to the UE a CSI report configuration for configuring the UE to include the first rank information in the CSI report.

65. The method of claim 59, wherein the method further comprises the network node adapting a transmission to the UE based on rank information included in the CSI report.

66. The method of claim 59, wherein the method further comprises the network node using rank information included in the CSI report to select a spatial filter from a set of spatial filters that includes a first spatial filter and a second spatial filter.

67. A user equipment, the user equipment comprising:
a receiver for receiving a first channel state information (CSI) reference signal (CSI-RS) transmitted from a network node; and
a transmitter for transmitting to the network node a CSI report, the CSI report comprising first rank information associated with at least the first reference signal, wherein
the first rank information specifies a first maximum number of downlink (DL) and/or uplink (UL) spatial layers supported by the UE, and
the CSI report further comprises a first measurement value associated with the first reference signal.

68. The UE of claim 67, wherein the UE is configured to determine the first rank information based on an antenna arrangement used to receive the CSI-RS.

69. A network node, the network node comprising:
a transmitter for transmitting a first channel state information (CSI) reference signal (CSI-RS); and
a receiver for receiving a CSI report transmitted from a user equipment (UE), wherein
the CSI report comprises first rank information associated with the first CSI reference signal and a first measurement value associated with the first CSI reference signal, and
the first rank information specifies a first maximum number of downlink (DL) and/or uplink (UL) spatial layers supported by the UE.

70. The network node of claim 69, wherein
the network node is configured to transmit a second CSI reference signal,
the CSI report further comprises second rank information associated with the second CSI reference signal, and
the second rank information specifies a second maximum number of DL and/or UL spatial layers supported by the UE.
